(19) United States
(12) Patent Application Publication
(10) Pub. No.: US 2025/0337444 A1
(43) Pub. Date: Oct. 30, 2025

(54) METHODS, SYSTEMS, AND COMPUTER READABLE MEDIA FOR COMPENSATING FOR COMPRESSION OF RADIO FREQUENCY SIGNALS BY A NETWORK ANALYZER

(71) Applicant: Keysight Technologies, Inc., Santa Rosa, CA (US)

(72) Inventor: Jan Maria Petrus Verspecht, Santa Rosa, CA (US)

(21) Appl. No.: 18/649,433

(22) Filed: Apr. 29, 2024

(51) Int. Cl. H04B 1/12; H04B 17/21

(52) U.S. Cl. CPC H04B 1/12; H04B 17/22

(57) ABSTRACT

A method for compensating for compression of radio frequency (RF) signals by a network analyzer includes receiving a set of measured values for test input signals to a reference receiver of a network analyzer and corresponding test output signals from a measurement receiver of the network analyzer, the test input signals comprising signals with various powers and frequencies. A compensation algorithm is generated based on a nonlinear relationship between power levels of the test output signals and the test input signals and a nonlinear relationship between phases of the test output signals and the test input signals that is configured to convert the nonlinear relationships to linear relationships. The compensation algorithm is applied to subsequent output signals from the measurement receiver.

### TECHNICAL FIELD

The subject matter described herein relates to compression of radio frequency (RF) signals by a network analyzer. More specifically, the subject matter relates to methods, systems, and computer readable media for compensating for compression of FR signals by a network analyzer.

### BACKGROUND

RF and microwave signal receivers, such as vector network analyzers (VNAs), compress incident signals to the measurement receiver such that the power levels and phases of the reflected signals are nonlinear in relation to that of their corresponding incident signals. The resulting nonlinear relationship between the incident and reflected signals at the measurement receiver results in distorted measurements. There is a need to compensate for the compression and maintain the linear relationship of power levels and phases between incident and reflected signals at the measurement receiver.

### SUMMARY

Methods, systems, and computer readable media for compensating for compression of radio frequency signals by a network analyzer are disclosed. An example method for compensating for compression of radio frequency (RF) signals by a network analyzer includes receiving, at a compensation module associated with a network analyzer, a set of measured values for test input signals to a reference receiver of the network analyzer and corresponding test output signals from a measurement receiver of the network analyzer, the test input signals including signals with various powers and frequencies. The method further includes generating, by the compensation module, a compensation algorithm based on a nonlinear relationship between power levels of the test output signals and the test input signals and a nonlinear relationship between phases of the test output signals and the test input signals that is configured to convert the nonlinear relationships to linear relationships. The method further includes applying, by the compensation module, the compensation algorithm to subsequently received input signals to the reference receiver of the network analyzer or subsequently generated output signals from a measurement receiver of the network analyzer to produce or approximate a linear relationship between power levels of the subsequently received input signals and subsequently generated output signals and a linear relationship between phases of the subsequently received input signals and subsequently generated test output signals.

According to another aspect of the subject matter described, the method includes determining a threshold power level above which the nonlinear relationship between power levels of the test input signals and corresponding test output signals appears.

According to another aspect of the method described, generating the compensation algorithm includes determining a frequency-dependent expansion operator that when applied to an output signal from the measurement receiver returns an estimate of a corresponding input signal to the measurement receiver that is proportional to an input signal to the measurement receiver and whereby the proportionality factor is independent of a power level of the input signal to the measurement receiver.

According to another aspect of the method described, determining the expansion operator includes minimizing a residual error between the estimated input signal and a measured value of the input signal to the reference receiver.

According to another aspect of the method described, minimizing the residual error includes using a least-squares-error fit of a polynomial Volterra model.

According to another aspect of the method described, the compensation algorithm is configured to compensate for compression of input signals including power levels of about one decibel (dB) or below.

According to another aspect of the method described, the network analyzer includes a vector network analyzer (VNA) receiver.

An example system for compensating for compression of radio frequency (RF) signals includes a compensation module associated with a network analyzer, the compensation module including at least one processor and a memory. The compensation module is implemented by the at least one processor for receiving a set of measured values for test input signals to a reference receiver of the network analyzer and corresponding test output signals from a measurement receiver of the network analyzer, the test input signals including signals with various powers and frequencies. The compensation module is further implemented by the at least one processor for generating a compensation algorithm based on a nonlinear relationship between power levels of the test output signals and the test input signals and a nonlinear relationship between phases of the test output signals and the test input signals that is configured to convert the nonlinear relationships to linear relationships. The compensation module is further implemented by the at least one processor for applying the compensation algorithm to subsequently received input signals to the reference receiver of the network analyzer or subsequently generated output signals from a measurement receiver of the network analyzer to produce or approximate a linear relationship between power levels of the subsequently received input signals and subsequently generated output signals and a linear relationship between phases of the subsequently received input signals and subsequently generated test output signals.

According to another aspect of the system described, the compensation module is configured for determining a threshold power level above which the nonlinear relationship between power levels of the test input signals and corresponding test output signals appears.

According to another aspect of the system described, generating the compensation algorithm includes determining a frequency-dependent expansion operator that when applied to an output signal from the measurement receiver returns an estimate of a corresponding input signal to the measurement receiver that is proportional to an input signal to the measurement receiver and whereby the proportionality factor is independent of a power level of the input signal to the measurement receiver.

According to another aspect of the system described, determining the expansion operator includes minimizing a residual error between the estimated input signal and a measured value of the input signal to the reference receiver.

According to another aspect of the system described, minimizing the residual error includes using a least-squares-error fit of a polynomial Volterra model.

According to another aspect of the system described, the compensation algorithm is configured to compensate for compression of input signals including power levels of about one decibel (dB) or below.

According to another aspect of the system described, the network analyzer includes a vector network analyzer (VNA) receiver.

An example non-transitory computer readable medium has stored thereon executable instructions that when executed by at least one processor of at least one computer cause the at least one computer to perform steps including receiving a set of measured values for test input signals to a reference receiver of the network analyzer and corresponding test output signals from a measurement receiver of the network analyzer, the test input signals including signals with various powers and frequencies. The steps further include generating a compensation algorithm based on a nonlinear relationship between power levels of the test output signals and the test input signals and a nonlinear relationship between phases of the test output signals and the test input signals that is configured to convert the nonlinear relationships to linear relationships. The steps further include applying the compensation algorithm to subsequently received input signals to the reference receiver of the network analyzer or subsequently generated output signals from a measurement receiver of the network analyzer to produce or approximate a linear relationship between power levels of the subsequently received input signals and subsequently generated output signals and a linear relationship between phases of the subsequently received input signals and subsequently generated test output signals.

According to another aspect of the example non-transitory computer readable medium, the steps include determining a threshold power level above which the nonlinear relationship between power levels of the test input signals and corresponding test output signals appears.

According to another aspect of the example non-transitory computer readable medium, generating the compensation algorithm includes determining a frequency-dependent expansion operator that when applied to an output signal from the measurement receiver returns an estimate of a corresponding input signal to the reference receiver that is independent of a power level.

According to another aspect of the example non-transitory computer readable medium, determining the expansion operator includes minimizing a residual error between the estimated input signal and a measured value of the input signal to the reference receiver.

According to another aspect of the example non-transitory computer readable medium, minimizing the residual error includes using a least-squares-error fit of a polynomial Volterra model.

According to another aspect of the example non-transitory computer readable medium, the compensation algorithm is configured to compensate for compression of input signals including power levels of about one decibel (dB) or below.

The subject matter described herein may be implemented in software in combination with hardware and/or firmware. For example, the subject matter described herein may be implemented in software executed by a processor. In one example implementation, the subject matter described herein may be implemented using a non-transitory computer readable medium having stored therein computer executable instructions that when executed by the processor of a computer control the computer to perform steps. Example computer readable media suitable for implementing the subject matter described herein include non-transitory devices, such as disk memory devices, chip memory devices, programmable logic devices, field-programmable gate arrays, and application specific integrated circuits. In addition, a computer readable medium that implements the subject matter described herein may be located on a single device or computer platform or may be distributed across multiple devices or computer platforms.

### BRIEF DESCRIPTION OF THE DRAWINGS

The subject matter described herein will now be explained with reference to the accompanying drawings of which:

FIG. 1 is a block diagram of a prior art single-port network analyzer;

FIG. 2A is a flow diagram illustrating a compression model;

FIG. 2B is a flow diagram illustrating an expansion model;

FIG. 3 is a block diagram illustrating an example system for compensating for compression of RF signals by a network analyzer;

FIG. 4 is a chart of linear amplitudes of α for various frequencies;

FIG. 5 is a chart of phase of α for various frequencies;

FIG. 6 is a chart of real and imaginary parts of β with polynomial fits;

FIG. 7 is a chart of real and imaginary parts of γ with polynomial fits; and

FIG. 8 is a flow diagram illustrating an example method for compensating for compression of RF signals by a network analyzer.

### DETAILED DESCRIPTION

The subject matter described herein includes methods, systems, and computer readable media for compensating for compression of RF signals by a network analyzer. A measurement receiver for RF and microwave signals, such as a measurement receiver in a vector network analyzer, compresses the received signal in a nonlinear process, causing the compressed output signal to be nonlinear in relation to the corresponding input signal. This nonlinear compression results in distorted measurements. The compensation module compensates for this nonlinear compression by determining and applying a compensation algorithm.

The compensation module determines a compensation algorithm based on collected measurements of input signals to the reference receiver and corresponding output signals to the measurement receiver. The compensation module then applies the determined compensation algorithm to a subsequent output signal from the measurement receiver to determine an estimate of the corresponding input signal to the measurement receiver, which is linear to the actual input signal to the measurement receiver.

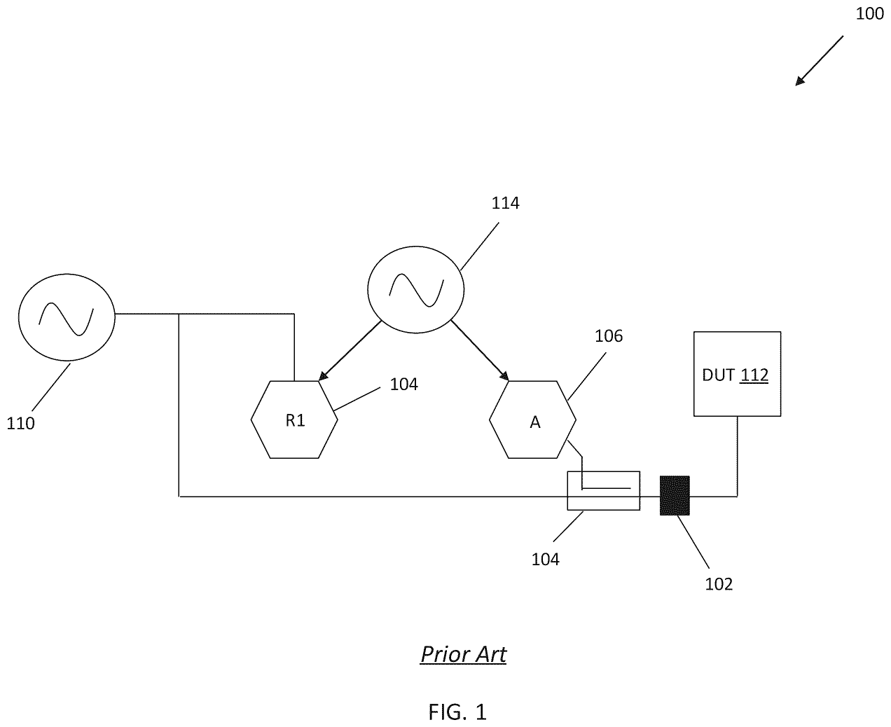

FIG. 1 is a block diagram of a prior art single-port network analyzer 100. Network analyzer 100 can includes RF frequency and/or microwave signal receivers. Network analyzer 100 can be, for example, a vector voltmeter or VNA. Network analyzer 100 includes a port 102 connected to two receivers, namely a reference receiver 104 and a measurement receiver 106, via a directional bridge 108 configured to separate outgoing signals from incoming signals. Network analyzer 100 includes a stimulus 110, which produces an RF stimulus signal and sends the stimulus signal to a Device Under Test (DUT) 112. DUT 112 can include, for example, an amplifier. DUT 112 can be connected to network analyzer 100 via port 102. DUT 112 receives the stimulus signal as an incident signal or input signal to the DUT 112 and outputs a signal that is an amplification of the stimulus signal. Reference receiver 104 senses the stimulus signal provided to DUT 112 by stimulus 110 as an incident or input signal to the reference receiver 104 and generates a digital representation of this input signal as a reflected signal or output signal. Measurement receiver 106 senses DUT's 112 output signal, which is an amplification of the stimulus signal, via directional bridge 108 as an incident signal or input signal to the measurement receiver 106. Measurement receiver 106 generates a digital representation of this input signal as the reflected signal or output signal at the measurement receiver 106. Measurement receiver 106 compresses this input signal nonlinearly to generate the digital representation, such that the power level and phase of the output signal from measurement receiver 106 have a nonlinear relationship to the power level and phase of the corresponding input signal at the measurement receiver 106. This nonlinear compression process results in distorted measurements by network analyzer 100. Network analyzer 100 includes a local oscillator 114, which is a mixer that mixes down signals to a low frequency while reducing noise.

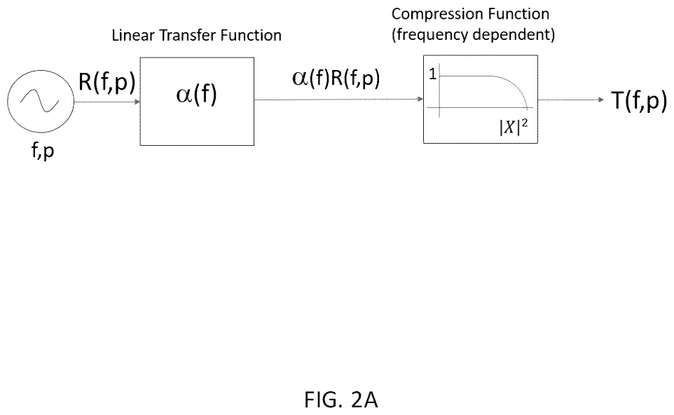

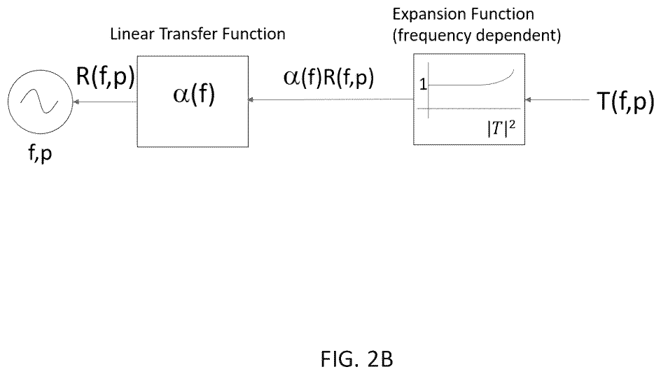

FIG. 2A is a flow diagram illustrating a compression model. FIG. 2A depicts a system level model of the compression mechanism, which is known as a Wiener model. In FIG. 2A, stimulus generates a stimulus signal with a frequency “f” and power level “p.” The stimulus signal is sensed by the reference receiver. A linear transfer function α(f) and a nonlinear compression function is performed on the stimulus signal before the measurement receiver outputs its signal. The RF frequency “f” and the power setting “p” is swept and the reference receiver phasor R(f,p) and the corresponding transmission receiver phasor T(f,p) are measured. Note that R(f,p) and T(f,p) are represented by complex numbers. There are two issues with the data processing that complicate the identification and compensation of the compression. The first issue is that the compression is assumed to be slightly frequency dependent, and the second issue is that only R(f,p) and T(f,p) can be measured. There is no direct way to measure α(f). FIG. 2B is a flow diagram illustrating an expansion model. This model, which is the inverse of a Wiener model, is known as a Hammerstein model.

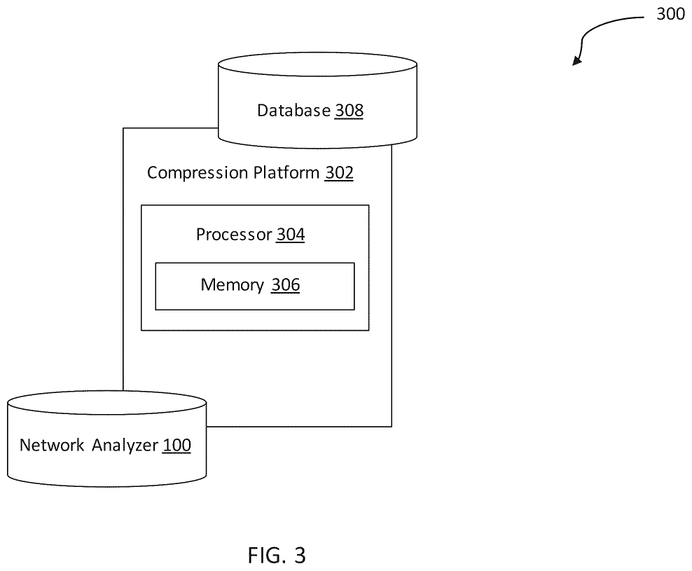

FIG. 3 is a block diagram illustrating an example system 300 for compensating for compression of RF signals by network analyzer 100. Although network analyzer 100 as shown in FIG. 1 is a single-port network analyzer with two receivers, namely reference receiver 104 and measurement receiver 106, it is understood that system 300 can also use a two-port network analyzer with four receivers, wherein only one of the ports and corresponding two receivers are implemented, or a two-port network analyzer wherein each port directs signals to a single receiver. Although system 300 is described herein in relation to network analyzer 100, the subject matter described herein can also apply to spectrum analyzer receivers or oscilloscopes. System 300 includes a compensation module 302. Compensation module 302 may include, without limitation, a microcontroller, microprocessor, digital signal processor (DSP) and/or system on a chip (SoC) as described herein. Compensation module 302 may include a single computing device operating independently, or may include two or more computing devices operating in concert, in parallel, sequentially or the like; two or more computing devices may be included together in a single computing device or in two or more computing devices. Compensation module 302, using processor 304 and memory 306, may be configured to perform any of the steps described herein. Compensation module 302 can include a database 308 from which the compensation module 302 can store, access, edit, and retrieve information such as datasets and graph-based representations of AI/ML workload executions, for example execution traces. Database 308 can include a cloud drive. Compensation module 302 is associated with network analyzer 100. Compensation module 302 can be communicatively connected to network analyzer 100 wherein the compensation module 302 and network analyzer 100 are configured to send and receive information between each other. In some aspects of the described subject matter, network analyzer 100 can include compensation module 302. In other aspects, compensation module 302 can be separate from network analyzer 100.

Compensation module 302 compensates for the nonlinear relationship between power level and phase of the incident and reflected signal at measurement receiver 106 in network analyzer 100. Compensation module 302 receives a set of measured values for test input signals to reference receiver 104 of network analyzer 100 and corresponding test output signals from measurement receiver 106 of the network analyzer 100, such as values of R(f,p) and T(f,p), respectively. The set of measured values can be obtained by measuring R(f,p) and T(f,p) at different power levels and frequencies of stimulus signal from stimulus 110. It is assumed that the input signal to the reference receiver 104 is a continuous wave (CW) RF excitation signal, as it occurs during legacy S-parameter measurements, or is a slowly varying CW signal. Such CW measurement conditions are typical for vector network analyzer receivers, but the method also applies to spectrum analyzer receivers or oscilloscopes.

The test input signals includes signals with various power levels and frequencies. The test input signals to reference receiver 104 are the stimulus signals provided by stimulus 100 as an input signal to DUT 112 and sensed by the reference receiver 104. The test output signals from measurement receiver 106 are digitized signals, generated by measurement receiver 106, of the signals output by DUT 112, which are amplified signals of the stimulus signals from stimulus 110. In other words, the output signals from measurement receiver 106 are the digitized signals of amplified stimulus signals. The nonlinear compression process can be avoided using signals having low power levels, so R(f,p) and T(f,p) are linear at low power levels.

Compensation module 302 generates a compensation algorithm based on a nonlinear relationship between power levels of the test output signals from measurement receiver 106 and the test input signals to reference receiver 104 and a nonlinear relationship between phases of the test output signals from the measurement receiver 106 and the test input signals to the reference receiver 104 that is configured to convert the nonlinear relationships to linear relationships. Compensation module 302 can determine a threshold power level above which the nonlinear relationship between power levels of the test input signals and corresponding test output signals appears.

A compression compensation algorithm can be mathematically formulated as follows: based on the measured values R(f,p) and T(f,p), find a frequency dependent expansion operator E[.,.] such that

$$E [ T ( f , p ) , f ] T ( f , p ) = α ( f ) R ( f , p ) , \qquad ( 1 )$$

with α(f) an arbitrary function exclusively of frequency “f”, not the power level “p”. This is the key property for the expansion operator: when applied to T(f,p), the expansion operator returns an estimated value for R(f,p) which is independent of the power level “p”. Determining the expansion operator can include minimizing a residual error between the estimated input signal and a measured value of the input signal to the reference receiver. In practice, measurement noise is always present, and it is difficult to identify such a function E[.,.] in an explicit way. A practical solution is provided by using a least-squares-error approach based on minimizing the root-mean-square value over power and frequency of the residual ε(f,p) defined as

$$ε ( f , p ) = E [ T ( f , p ) , f ] T ( f , p ) - α ( f ) R ( f , p ) . \qquad ( 2 )$$

In the following, the expansion model is extracted through a least-squares-error minimization of a polynomial model in power that is consistent with Volterra theory. This expansion model is given by

$$E [ T , f ] = 1 + β ( f ) {\vert T \vert}^{2} + γω {\vert T \vert}^{4} , \qquad ( 3 )$$

with β(f) and γ(f) being smooth functions of frequency, which, on their turn, can be approximated by low degree polynomial functions of “f”. Any even orders beyond the fourth order can also be included in Equation (3).

### Least-Squares-Error Approach

The goal of the first step is to determine α(f), β(f), and γ(f) from a set of measured values for R(f,p) and T(f,p). Note that the determination of the expansion function only requires β(f), and γ(f), with α(f) being redundant as its effect is removed through the linear calibration process.

Consistent with Equations (1) and (2), the least-squares-error solution for these a priori unknown functions is based on the residual ε as defined below:

$$ε ( f , p ) = T ( f , p ) ( 1 + β ( f ) {\vert T ( f , p ) \vert}^{2} + γω {\vert T ( f , p ) \vert}^{4} ) - α ( f ) R ( f , p ) . \qquad ( 4 )$$

Estimates for the frequency dependent functions α(f), β(f), and γ(f) are found by minimizing the integral of the residual amplitude squared |ε(f,p)|² over the different power levels. This integral, which is a function of frequency, but not of power, is represented by Σ(f):

$$\sum ( f ) = {\int }_{0}^{{p}_{MAX}} ε ( f , p ) {ε}^{*} ( f , p ) dp . \qquad ( 5 )$$

It is understood that an integral is used rather than a discrete sum for keeping the mathematical notation more elegant and compact. The superscript “*” stands for conjugate. In any practical implementation the integral is replaced by the equivalent finite sum over the measured data.

The compensation algorithm can be configured to compensate for compression of input signals to measurement receiver 106 with power levels of about one decibel (dB) or below. The estimation assumes a low degree polynomial model. This requires the elimination of all data points with a T amplitude that is above a level that roughly corresponds to 1 dB of compression. A level of 1 dB of compression is used as this represents a level where the expansion can still be described by a low order polynomial. In other aspects of the described subject matter, a threshold level below or above 1 dB of compression can be used.

The estimated values for α(f), β(f), and γ(f), denoted by [symbol] , [symbol] , and [symbol] are calculated by using Wirtinger calculus and solving the following set of equations.

$$\frac{\partial \sum }{\partial {α}^{*}} ( , , ) = 0 \qquad ( 6 )$$

$$\frac{\partial \sum }{\partial {β}^{*}} ( , , ) = 0 \qquad ( 7 )$$

$$\frac{\partial \sum }{\partial {γ}^{*}} ( , , ) = 0 \qquad ( 8 )$$

The above equations are linear in the unknown parameters and can be solved for ( [symbol] , [symbol] , [symbol] ) in a straightforward way. The linear equation to be solved can be represented as

$${M}^{=} \cdot [ \begin{matrix} \\ \\ \end{matrix} ] = \overline{L} , \qquad ( 9 )$$

$$with$$

$${M}_{11} = {\int }_{0}^{{p}_{MAX}} {R}^{*} ( f , p ) R ( f , p ) dp \qquad ( 10 )$$

$${M}_{12} = {\int }_{0}^{{p}_{MAX}} - {R}^{*} ( f , p ) {\vert T ( f , p ) \vert}^{2} T ( f , p ) dp \qquad ( 11 )$$

$${M}_{13} = {\int }_{0}^{{p}_{MAX}} - {R}^{*} ( f , p ) {\vert T ( f , p ) \vert}^{4} T ( f , p ) dp \qquad ( 12 )$$

$${M}_{21} = {M}_{12}^{*} \qquad ( 13 )$$

$${M}_{22} = {\int }_{0}^{{p}_{MAX}} {\vert T ( f , p ) \vert}^{6} dp \qquad ( 14 )$$

$${M}_{23} = {\int }_{0}^{{p}_{MAX}} {\vert T ( f , p ) \vert}^{8} dp \qquad ( 15 )$$

$${M}_{31} = {M}_{13}^{*} \qquad ( 16 )$$

$${M}_{32} = {M}_{23}^{*} \qquad ( 17 )$$

$${M}_{33} = {\int }_{0}^{{p}_{MAX}} {\vert T ( f , p ) \vert}^{10} dp \qquad ( 18 )$$

$${L}_{1} = {\int }_{0}^{{p}_{MAX}} {R}^{*} ( f , p ) T ( f , p ) dp \qquad ( 19 )$$

$${L}_{2} = {\int }_{0}^{{p}_{MAX}} - \vert T ( f , p ) \vert dp \qquad ( 20 )$$

$${L}_{3} = {\int }_{0}^{{p}_{MAX}} - {\vert T ( f , p ) \vert}^{6} dp . \qquad ( 21 )$$

Once [symbol] , [symbol] , and [symbol] have been determined, one can inspect the smoothness of [symbol] and [symbol] and approximate these functions by a low degree polynomial. In practice we found that a third-degree polynomial is sufficient. The resulting polynomials are denoted by β_{POL}(f) and γ_{POL}(f) and are given by the following equations:

$${β}_{POL} ( f ) = {β}_{0} + {β}_{1} f + {β}_{2} {f}^{2} + {β}_{3} {f}^{3} , \qquad ( 22 )$$

$$and$$

$${γ}_{POL} ( f ) = {γ}_{0} + {γ}_{1} f + {γ}_{2} {f}^{2} + {γ}_{3} {f}^{3} . \qquad ( 23 )$$

The 8 complex coefficients β₀ to β₃, and γ₀ to γ₃ are found by minimizing the corresponding least-squares-error residuals ε₁ and ε₂, which are defined as follows.

$${ε}_{1} = {\int }_{0}^{{f}_{MAX}} {\vert - {β}_{0} + {β}_{1} f + {β}_{2} {f}^{2} + {β}_{3} {f}^{3} \vert}^{2} df , \qquad ( 24 )$$

$$and$$

$${ε}_{2} = {\int }_{0}^{{f}_{MAX}} {\vert - {γ}_{0} + {γ}_{1} f + {γ}_{2} {f}^{2} + {γ}_{3} {f}^{3} \vert}^{2} df . \qquad ( 25 )$$

This finally results in a set of 8 complex coefficients which can describe the expansion characteristic with sufficient accuracy.

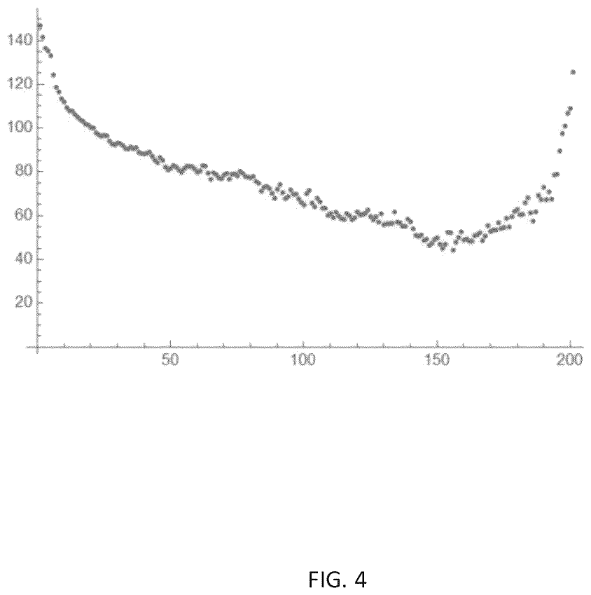

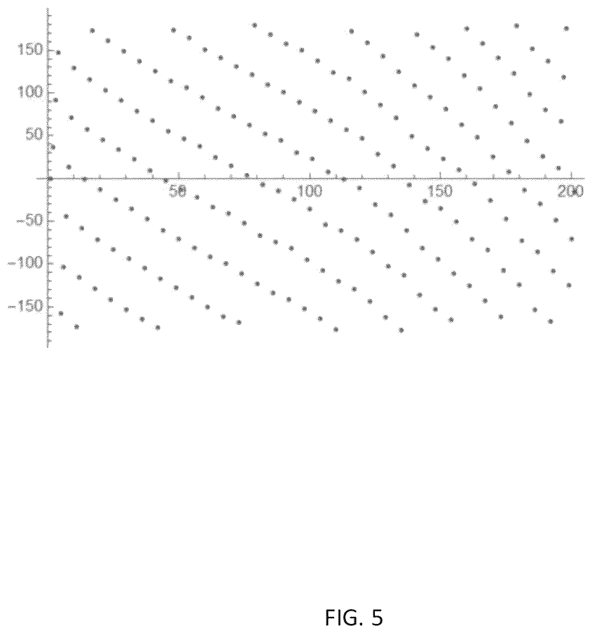

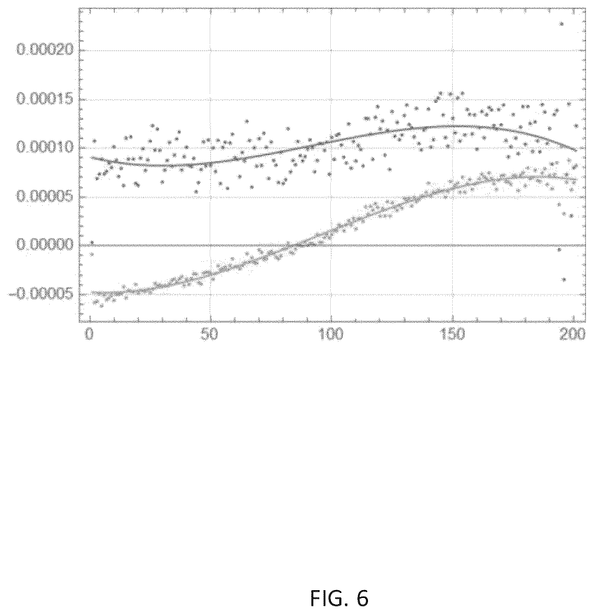

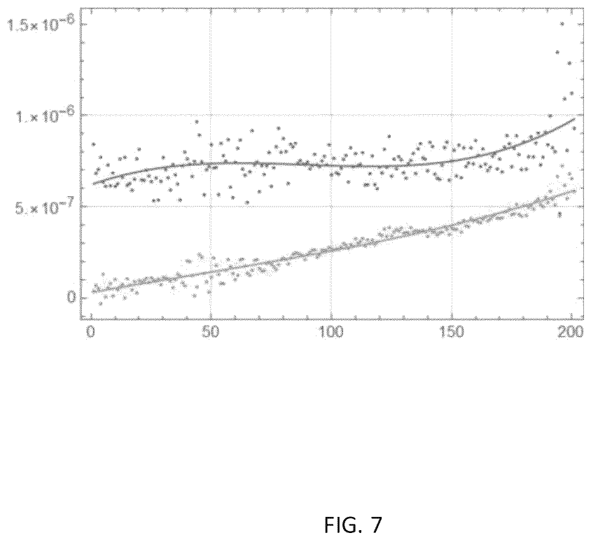

FIGS. 4-7 show values for α, β, and γ plotted on the y-axes for 200 various frequency points between 10 MHz and 26.5 GHz, which can be the frequency range of a network analyzer. FIG. 4 is a chart of linear amplitudes of α, which is an arbitrary unit. FIG. 5 is a chart of phase of α in degrees. There is no need, nor would it be a good idea, to fit a polynomial model to the α in FIGS. 4 and 5. This is redundant data that captures the linear dispersion of the system. Note that the phase is wrapped because of the presence of significant delays in the structure. FIG. 6 is a chart of real parts (above) and imaginary parts (below) of β with polynomial fits for each as represented by the two lines. FIG. 7 is a chart of real parts (above) and imaginary parts (below) of γ with polynomial fits for each as represented by the two lines. Beta and Gamma capture the pure nonlinear compression of measurement receiver 106, which explains why they are relatively smooth versus frequency (compared to alpha, which describes the linear dispersion).

Besides investigating the residual, the quality of the derived expansion function can be checked by plotting, for a fixed frequency, the gain as a function of power, both before and after compensation. For a fixed frequency “f” we plot the uncompensated gain R(f,p)/T(f,p) versus |T(f,p)|² and compare with the compensated gain R(f,p)/T(f,p)/E[T(f,p),f] versus |T(f,p)|². These plots will directly reveal the accuracy of the compensation and will also reveal at what point the model becomes invalid.

### Observations and Further Optimization

The original dataset that was used contained 201 frequency points and 201 power points, whereby the power was swept uniform in dBm. The model is expressed as a polynomial in the amplitude squared. As a result, most of the logarithmically swept power points are performed at power levels that are too low to provide meaningful information on the expansion coefficients β(f) and γ(f). In other words, most of these measurements at low power levels can completely be ignored or eliminated without significantly changing the result. With the number of unknowns equal to 3, it is to be expected that about 30 power levels will be sufficient, on the condition that they are uniformly distributed in amplitude squared (or power).

Another aspect is the frequency dependency of the expansion coefficients. As it takes 4 parameters, it is expected that about 40 frequency points should be sufficient. This makes for a total of 1200 power and frequency points, which is about 30 times less as the original data set that had 201 power points and 201 frequency points.

If higher precision is required, or if one wants to push towards compensating higher levels of compression, the degree of the polynomial approximations can be increased. This must be done with care, though, as the problem can become numerically ill-conditioned, and wiggles will start appearing. In some aspects of the described subject matter, orthogonal polynomials instead of monomials, like Legendre polynomials, or the use of more robust fitting techniques, like for example neural networks or piecewise polynomial splines, can be used instead of the method of polynomial fitting described herein.

Another potential way to improve overall precision is to perform the estimation of all unknown parameters through one residual, rather than doing the two-tier approach of first identifying the coefficients of the polynomial versus power, and next identity the coefficients of the polynomial versus frequency. It must be noted that, although coefficients β(f) and γ(f) can be approximated by low degree polynomials, α(f) is of a different nature as it corresponds to the frequency response function of the receiver.

Referring again to FIG. 3, compensation module 302 applies the compensation algorithm to subsequently received input signals to reference receiver 104 of network analyzer 100 or subsequently generated output signals from measurement receiver 106 of the network analyzer 100 to produce or approximate a linear relationship between power levels of the subsequently received input signals and subsequently generated output signals and a linear relationship between phases of the subsequently received input signals and subsequently generated test output signals. For example, compensation module 302 can apply the compensation algorithm to an output signal from measurement receiver 106 and generate an estimated corresponding input signal to the measurement receiver 106 that is linear to the actual input signal to the measurement receiver 106. Generating the compensation algorithm can include determining a frequency-dependent expansion operator, E[.,.], that when applied to an output signal from measurement receiver 106 returns an estimate of a corresponding input signal to the measurement receiver 106 that is proportional to an input signal to the measurement receiver 106 and whereby the proportionality factor is independent of a power level of the input signal to the measurement receiver 106.

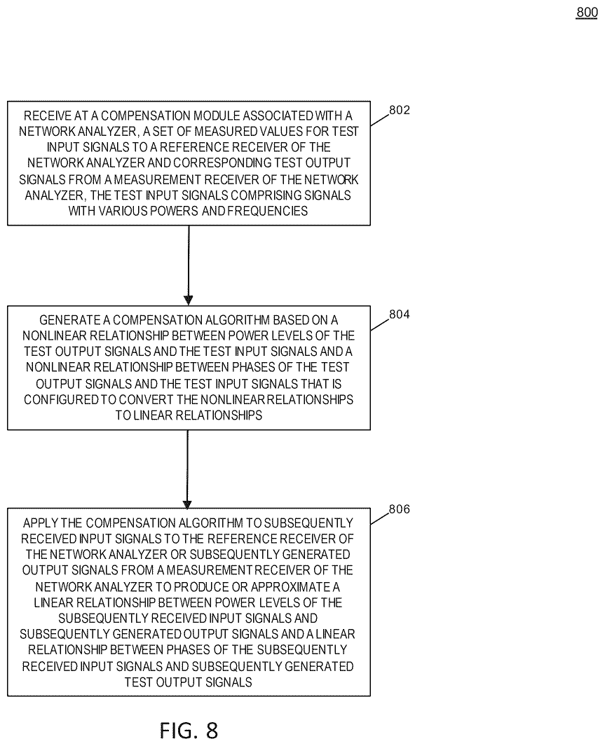

FIG. 8 is a flow diagram illustrating an example method 800 for compensating for compression of RF signals by a network analyzer. At step 802, a compensation module associated with a network analyzer receives a set of measured values for test input signals to a reference receiver of the network analyzer and corresponding test output signals from a measurement receiver of the network analyzer. The test input signals include signals with various powers and frequencies. The network analyzer can be a VNA receiver.

At step 804, the compensation module generates a compensation algorithm based on a nonlinear relationship between power levels of the test output signals and the test input signals and a nonlinear relationship between phases of the test output signals and the test input signals that is configured to convert the nonlinear relationships to linear relationships. The compensation module can determine a threshold power level above which the nonlinear relationship between power levels of the test input signals and corresponding test output signals appears. Generating the compensation algorithm can include determining a frequency-dependent expansion operator that when applied to an output signal from the measurement receiver returns an estimate of a corresponding input signal to the measurement receiver that is proportional to an input signal to the measurement receiver and whereby the proportionality factor is independent of a power level of the input signal to the measurement receiver. Determining the expansion operator can include minimizing a residual error between the estimated input signal and a measured value of the input signal to the reference receiver. The compensation module can use a least-squares-error fit of a polynomial Volterra model to minimize the residual error. The compensation algorithm can be configured to compensate for compression of input signals including power levels of about one decibel (dB) or below.

At step 806, the compensation module applies the compensation algorithm to subsequently received input signals to the reference receiver of the network analyzer or subsequently generated output signals from a measurement receiver of the network analyzer to produce or approximate a linear relationship between power levels of the subsequently received input signals and subsequently generated output signals and a linear relationship between phases of the subsequently received input signals and subsequently generated test output signals.

It will be appreciated that method 800 is for illustrative purposes and that different and/or additional actions may be used. It will also be appreciated that various actions described herein may occur in a different order or sequence. It will be understood that various details of the subject matter described herein may be changed without departing from the scope of the subject matter described herein. Furthermore, the foregoing description is for the purpose of illustration only, and not for the purpose of limitation, as the subject matter described herein is defined by the claims as set forth hereinafter.

What is claimed is:

1. A method for compensating for compression of radio frequency (RF) signals by a network analyzer, the method comprising:
receiving, at a compensation module associated with a network analyzer, a set of measured values for test input signals to a reference receiver of the network analyzer and corresponding test output signals from a measurement receiver of the network analyzer, the test input signals comprising signals with various powers and frequencies;
generating, by the compensation module, a compensation algorithm based on a nonlinear relationship between power levels of the test output signals and the test input signals and a nonlinear relationship between phases of the test output signals and the test input signals that is configured to convert the nonlinear relationships to linear relationships; and
applying, by the compensation module, the compensation algorithm to subsequently received input signals to the reference receiver of the network analyzer or subsequently generated output signals from a measurement receiver of the network analyzer to produce or approximate a linear relationship between power levels of the subsequently received input signals and subsequently generated output signals and a linear relationship between phases of the subsequently received input signals and subsequently generated test output signals.

2. The method of claim 1 comprising determining a threshold power level above which the nonlinear relationship between power levels of the test input signals and corresponding test output signals appears.

3. The method of claim 1 wherein generating the compensation algorithm comprises determining a frequency-dependent expansion operator that when applied to an output signal from the measurement receiver returns an estimate of a corresponding input signal to the measurement receiver that is proportional to an input signal to the measurement receiver and whereby the proportionality factor is independent of a power level of the input signal to the measurement receiver.

4. The method of claim 3 wherein determining the expansion operator comprises minimizing a residual error between the estimated input signal and a measured value of the input signal to the reference receiver.

5. The method of claim 4 wherein minimizing the residual error comprises using a least-squares-error fit of a polynomial Volterra model.

6. The method of claim 1 wherein the compensation algorithm is configured to compensate for compression of input signals comprising power levels of about one decibel (dB) or below.

7. The method of claim 1 wherein the network analyzer comprises a vector network analyzer (VNA) receiver.

8. A system for compensating for compression of radio frequency (RF) signals, the system comprising:
a compensation module associated with a network analyzer, the compensation module including at least one processor and a memory, the compensation module implemented by the at least one processor for:
receiving a set of measured values for test input signals to a reference receiver of the network analyzer and corresponding test output signals from a measurement receiver of the network analyzer, the test input signals comprising signals with various powers and frequencies;
generating a compensation algorithm based on a nonlinear relationship between power levels of the test output signals and the test input signals and a nonlinear relationship between phases of the test output signals and the test input signals that is configured to convert the nonlinear relationships to linear relationships; and
applying the compensation algorithm to subsequently received input signals to the reference receiver of the network analyzer or subsequently generated output signals from a measurement receiver of the network analyzer to produce or approximate a linear relationship between power levels of the subsequently received input signals and subsequently generated output signals and a linear relationship between phases of the subsequently received input signals and subsequently generated test output signals.

9. The system of claim 8 wherein the compensation module is configured for determining a threshold power level above which the nonlinear relationship between power levels of the test input signals and corresponding test output signals appears.

10. The system of claim 8 wherein generating the compensation algorithm comprises determining a frequency-dependent expansion operator that when applied to an output signal from the measurement receiver returns an estimate of a corresponding input signal to the measurement receiver that is proportional to an input signal to the measurement receiver and whereby the proportionality factor is independent of a power level of the input signal to the measurement receiver.

11. The system of claim 10 wherein determining the expansion operator comprises minimizing a residual error between the estimated input signal and a measured value of the input signal to the reference receiver.

12. The system of claim 11 wherein minimizing the residual error comprises using a least-squares-error fit of a polynomial Volterra model.

13. The system of claim 8 wherein the compensation algorithm is configured to compensate for compression of input signals comprising power levels of about one decibel (dB) or below.

14. The system of claim 8 wherein the network analyzer comprises a vector network analyzer (VNA) receiver.

15. A non-transitory computer readable medium having stored thereon executable instructions that when executed by at least one processor of at least one computer cause the at least one computer to perform steps comprising:
receiving a set of measured values for test input signals to a reference receiver of the network analyzer and corresponding test output signals from a measurement receiver of the network analyzer, the test input signals comprising signals with various powers and frequencies;
generating a compensation algorithm based on a nonlinear relationship between power levels of the test output signals and the test input signals and a nonlinear relationship between phases of the test output signals and the test input signals that is configured to convert the nonlinear relationships to linear relationships; and
applying the compensation algorithm to subsequently received input signals to the reference receiver of the network analyzer or subsequently generated output signals from a measurement receiver of the network analyzer to produce or approximate a linear relationship between power levels of the subsequently received input signals and subsequently generated output signals and a linear relationship between phases of the subsequently received input signals and subsequently generated test output signals.

16. The non-transitory computer readable medium of claim 15 wherein the steps comprise determining a threshold power level above which the nonlinear relationship between power levels of the test input signals and corresponding test output signals appears.

17. The non-transitory computer readable medium of claim 15 wherein generating the compensation algorithm comprises determining a frequency-dependent expansion operator that when applied to an output signal from the measurement receiver returns an estimate of a corresponding input signal to the reference receiver that is independent of a power level.

18. The non-transitory computer readable medium of claim 17 wherein determining the expansion operator comprises minimizing a residual error between the estimated input signal and a measured value of the input signal to the reference receiver.

19. The non-transitory computer readable medium of claim 18 wherein minimizing the residual error comprises using a least-squares-error fit of a polynomial Volterra model.

20. The non-transitory computer readable medium of claim 15 wherein the compensation algorithm is configured to compensate for compression of input signals comprising power levels of about one decibel (dB) or below.
